(19) United States
(12) Patent Application Publication
(10) Pub. No.: US 2025/0339770 A1
(43) Pub. Date: Nov. 6, 2025

(54) GRAPHIC PROCESSING METHOD, APPARATUS AND DEVICE, AND MEDIUM

(71) Applicant: BEIJING ZITIAO NETWORK TECHNOLOGY CO., LTD., Beijing (CN)

(72) Inventor: Guanjun GUO, Beijing (CN)

(21) Appl. No.: 18/259,809

(22) PCT Filed: Dec. 6, 2021
(86) PCT No.: PCT/CN2021/135689

§ 371 Date: Dec. 11, 2023

(30) Foreign Application Priority Data
Jan. 22, 2021 (CN) 202110091007.9

(51) Int. Cl. A63F 13/52; G06F 18/22; G06T 3/60; G06T 7/33; G06T 7/60

(52) U.S. Cl. CPC A63F 13/52; G06F 18/22; G06T 3/60; G06T 7/33; G06T 7/60

(57) ABSTRACT

A graphic processing method, apparatus and device, and a medium are provided. The graphic processing method includes: acquiring a target graphic and a target sequence of pieces for forming the target graphic, performing matching calculation on the to-be-matched object groups to obtain matching state parameters of target matching object groups, and traversing the matching state parameters to obtain at least one target state parameter group. The target state parameter group is used in splicing the target sequence of pieces into the target graphic, the target state parameter group includes a plurality of target matching state parameters, and one target matching state parameter corresponds to a target matching object group to which one piece belongs.

This application is the national phase of International Application No. PCT/CN2021/135689, filed on Dec. 6, 2021, which claims the priority to Chinese patent application No. 202110091007.9, titled “GRAPHIC PROCESSING METHOD, APPARATUS AND DEVICE, AND MEDIUM”, filed on Jan. 22, 2021, both of which are incorporated herein by reference in their entireties.

### FIELD

The present disclosure relates to the field of graphic processing technology, and in particular to a graphic processing method, a graphic processing apparatus, a graphic processing device and a medium.

### BACKGROUND

At present, as an educational teaching aid, a tiling puzzle game often appears in various educational games.

After a user enters the tiling puzzle game, a tiling puzzle is provided in the game, and the user may solve the tiling puzzle. After the user solves the tiling puzzle, detection is performed on the solved puzzle. If the solved puzzle matches any pre-designed puzzle answer, it is determined that the user correctly solves the puzzle. In general, the puzzle answer is usually designed manually by a developer, which leads to the long time consumption for designing the puzzle answer and reduces the efficiency of developing the tiling puzzle game.

### SUMMARY

In order to solve the above technical problems or at least partially solve the above technical problems, a method, an apparatus and a graphic processing device, and a medium are provided according to the present disclosure.

In a first aspect, a graphic processing method is provided according to the present disclosure. The method includes:
acquiring a target graphic and a target sequence of pieces for forming the target graphic, where shape regions in the target graphic and pieces in the target sequence of pieces are paired one to one to form multiple to-be-matched object groups, where one to-be-matched object group includes one shape region and one piece:
performing matching calculation on the to-be-matched object groups to obtain matching state parameters of target matching object groups, where the target matching object group is a to-be-matched object group that meets a preset matching condition: and
traversing the matching state parameters to obtain at least one target state parameter group, where the target state parameter group is used in splicing the target sequence of pieces into the target graphic, the target state parameter group includes multiple target matching state parameters, and one target matching state parameter corresponds to a target matching object group to which one piece belongs.

In a second aspect, a graphic processing apparatus is provided according to the present disclosure. The apparatus includes an acquisition unit, a matching unit and a traversing unit.

The acquisition unit is configured to acquire a target graphic and a target sequence of pieces for forming the target graphic, where shape regions in the target graphic and pieces in the target sequence of pieces are paired one to one to form multiple to-be-matched object groups, where one to-be-matched object group includes one shape region and one piece.

The matching unit is configured to perform matching calculation on the to-be-matched object groups to obtain matching state parameters of target matching object groups, where the target matching object group is a to-be-matched object group that meets a preset matching condition.

The traversing unit is configured to traverse the matching state parameters to obtain at least one target state parameter group, where the target state parameter group is used in splicing the target sequence of pieces into the target graphic, the target state parameter group includes multiple target matching state parameters, and one target matching state parameter corresponds to a target matching object group to which one piece belongs.

In a third aspect, a graphic processing device is provided according to the present disclosure. The device includes a processor and a memory configured to store executable instructions.

The processor is configured to read the executable instructions from the memory and execute the executable instructions to implement the graphic processing method according to the first aspect.

In a fourth aspect, a computer readable storage medium storing a computer program is provided according to the present disclosure. The computer program, when executed by a processor, causes the processor to implement the graphic processing method according to the first aspect.

In a fifth aspect, a computer program product storing a computer program is provided according to the present disclosure. The computer program, when executed by a processor, causes the processor to implement the graphic processing method according to the first aspect.

Compared with the conventional technology, the technical solutions according to the embodiments of the present disclosure at least have the following advantages.

In the method, the apparatus and the graphic processing device, and the medium according to the embodiments of the present disclosure, after acquiring a target graphic and a target sequence of pieces for forming the target graphic, matching calculation may be performed on multiple to-be-matched object groups formed by combining shape regions in the target graphic and pieces in the target sequence of pieces one to one, to obtain multiple matching state parameters of target matching object groups that meet a preset matching condition. Moreover, the matching state parameters are traversed to obtain at least one target state parameter group based on which the target sequence of pieces is spliced into the target graphic. Thus, automatic design of a puzzle answer for a tiling puzzle is realized, which reduces the time consumption for designing the puzzle answer and improves the efficiency of developing a tiling puzzle game.

### BRIEF DESCRIPTION OF THE DRAWINGS

In conjunction with the drawings and with reference to the following embodiments, the above and other features, advantages and aspects of the embodiments of the present disclosure are more apparent. Throughout the drawings, the same or similar reference numbers refer to the same or similar elements. It should be understood that the drawings are schematic and that the components and elements are not necessarily drawn to scale.

FIG. 1 is a schematic flowchart of a graphic processing method according to an embodiment of the present disclosure:

FIG. 2 is a schematic diagram of a target graphic according to an embodiment of the present disclosure:

FIG. 3 is a schematic diagram of a scene in which a key point is superposed on a piece vertex according to an embodiment of the present disclosure:

FIG. 4 is a schematic diagram of a scene of rotating a piece according to an embodiment of the present disclosure:

FIG. 5 is a schematic flowchart of a graphic processing method according to another embodiment of the present disclosure:

FIG. 6 is a schematic diagram of a puzzle answer transformation result according to an embodiment of the present disclosure:

FIG. 7 is a schematic structural diagram of a graphic processing apparatus according to an embodiment of the present disclosure; and

FIG. 8 is a schematic structural diagram of a graphic processing device according to an embodiment of the present disclosure.

### DETAILED DESCRIPTION OF EMBODIMENTS

The embodiments of the present disclosure are described in detail below with reference to the drawings. Although some embodiments of the present disclosure are shown in the drawings, it should be understood that the present disclosure may be implemented in various forms and should not be limited to the embodiments. The embodiments are provided for thoroughly and completely understanding the present disclosure. It should be understood that the drawings and the embodiments of the present disclosure are exemplary and are not intended to limit the protection scope of the present disclosure.

It should be understood that the steps in the method embodiments of the present disclosure may be performed in different orders and/or in parallel. In addition, the method embodiments may include additional steps and/or some illustrated steps may be omitted. The scope of the present disclosure is not limited in this aspect.

The term “include” and its variations in the present disclosure mean open-ended inclusion, that is, “including but not limited to”. The term “based on” means “based at least in part on”. The term “one embodiment” means “at least one embodiment”. The term “another embodiment” means “at least one additional embodiment”. The term “some embodiments” means “at least some embodiments”. The definitions of other terms are provided in the following descriptions.

It should be noted that the wordings such as “first” and “second” mentioned in the present disclosure are used to distinguish different devices, modules or units, and are not used to limit an sequential order or interdependence of the functions performed by the devices, modules or units.

It should be noted that the wordings such as “one” and “multiple” mentioned in the present disclosure are illustrative and not restrictive. Those skilled in the art should understand that the modifications should be understood as “one or more” unless otherwise expressly indicated in the context.

The name of a message or information exchanged between devices in the embodiments of the present disclosure are only for illustrative purposes, and are not intended to limit the scope of the message or information.

At present, after a user enters a tiling puzzle game, a tiling puzzle is provided in the game, and the user may solve the tiling puzzle. After the user solves the tiling puzzle, detection is performed on the solved puzzle. If the solved puzzle matches any pre-designed puzzle answer, it is determined that the user correctly solves the puzzle. In general, the puzzle answer is usually designed manually by a developer, which leads to the long time consumption for designing the puzzle answer and reduces the efficiency of developing the tiling puzzle game, and is often difficult to cover all the answers.

In order to solve the above problems, a graphic processing method, a graphic processing apparatus, a graphic processing device and a medium capable of automatically designing a puzzle answer for a tiling puzzle are provided according to the embodiments of the present disclosure.

The graphic processing method according to an embodiment of the present disclosure is described hereinafter.

In some embodiments of the present disclosure, the graphic processing method may be performed by a graphic processing device. The graphic processing device may be a server, an electronic device, or other devices, which is not limited here. The server may be a device with storage and calculation functions such as a cloud server or a server cluster. The electronic device may include a device with communication function such as a mobile phone, a tablet computer, a desktop computer, a notebook computer, an in-vehicle terminal, a wearable electronic device, an all-in-one computer, and a smart home device, or may be a device simulated with a virtual machine or an emulator.

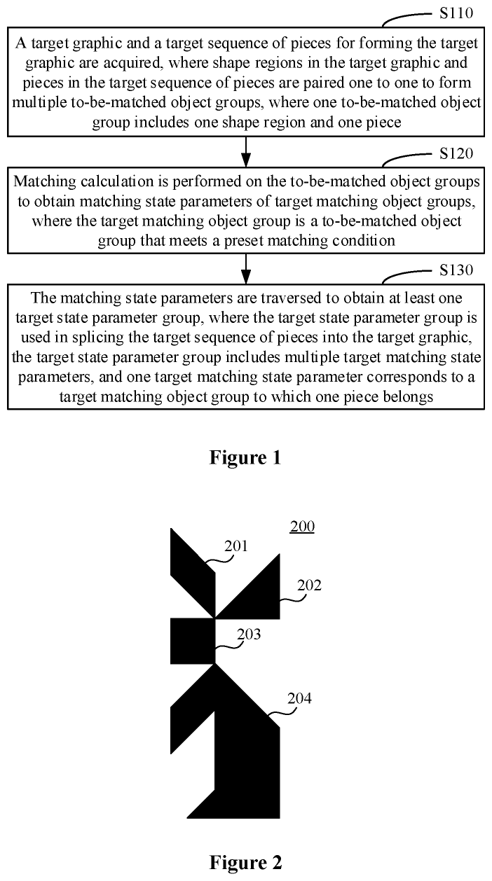

FIG. 1 shows a schematic flowchart of a graphic processing method according to an embodiment of the present disclosure.

As shown in FIG. 1, the graphic processing method may include the following steps S110 to S130.

In S110, a target graphic and a target sequence of pieces for forming the target graphic are acquired, where shape regions in the target graphic and pieces in the target sequence of pieces are paired one to one to form multiple to-be-matched object groups, where one to-be-matched object group includes one shape region and one piece.

In an embodiment of the present disclosure, the target graphic may include at least one shape region. The shape region is a closed region enclosed by at least a part of outer contour of the target graphic.

FIG. 2 shows a schematic diagram of a target graphic according to an embodiment of the present disclosure.

As shown in FIG. 2, the outer contour of the target graphic 200 may form four closed regions, each of which constitutes a shape region. Therefore, the target graphic 200 shown in FIG. 2 may include four shape regions, i.e., a diamond shape region 201, a triangle shape region 202, a square shape region 203 and an irregular shape region 204.

In an embodiment of the present disclosure, the target sequence of pieces may be a sequence of pieces formed by arranging pieces of a target tiling puzzle in a preset sequence order.

The target tiling puzzle may be any type of tiling puzzle. For example, the target tiling puzzle may be a 4-piece tiling puzzle, a 5-piece tiling puzzle, a tangram, and a 13-piece tiling puzzle, which is not limited here.

In an embodiment of the present disclosure, optionally, the preset sequence order may be a descending order of piece area, or the preset sequence order may be an ascending order of piece area, which is not limited here.

Optionally, if at least two pieces with a same piece area exist in the target sequence of pieces, the pieces with the same piece area may be randomly sorted.

A tangram is taken as an example. The tangram may be composed of seven pieces, and one piece corresponds to one color. The seven pieces may include two first triangle pieces, one second triangle piece, two third triangle pieces, one square piece, and one parallelogram piece. The two first triangle pieces are pieces with a same attribute, and the two third triangle pieces are pieces with a same attribute. The piece areas of the first triangle piece, the second triangle piece and the third triangle piece are decreased sequentially. The piece areas of the second triangle piece, the square piece and the parallelogram piece are the same.

In an embodiment, having the same attribute indicates a piece shape and having piece area, and having different attributes indicate being different in at least one of the piece shape and the piece area.

If the preset sequence order is descending order of piece area, the sequence of pieces of the tangram arranged in the preset sequence order may be: a first triangle piece of a first color, a first triangle piece of a second color, a second triangle piece of a third color, a second triangle piece of a fourth color, a parallelogram piece of a fifth color, a third triangle piece of a sixth color and a third triangle piece of a seventh color.

The first color, the second color, the third color, the fourth color, the fifth color, the sixth color and the seventh color may be different random colors, which is not limited here.

In an embodiment of the present disclosure, in a case that matchings between pieces and shape regions are unknown, each piece and each shape region have a possibility of matching. Therefore, shape regions in the target graphic and pieces in the target sequence of pieces may be paired one to one, i.e., each shape region and each piece are paired, to form multiple to-be-matched object groups each including one shape region and one piece, to realize pairwise matching detection between the pieces and the shape regions.

FIG. 2 is still taken as an example. If the target graphic 200 may be formed by splicing the target sequence of pieces of the tangram, it is needed to pair seven pieces in the target sequence of pieces with four shape regions in the target graphic 200 one to one, to obtain 49 to-be-matched object groups of different combinations of pieces and shape regions, so as to realize pairwise matching detection between the pieces in the tangram and the shape regions in the target graphic 200.

Returning to S110 in FIG. 1, in an embodiment of the present disclosure, the graphic processing device may acquire a target image input by a user for acquiring a target graphic, so that the graphic processing device may extract the target graphic from the target image, and acquire a target sequence of pieces for forming the target graphic.

In some embodiments of the present disclosure, the target image may be an image including the target graphic. The graphic processing device may acquire the target image, and perform edge detection on the target image to obtain an outer contour of the target graphic, and then segment the target graphic out of the target image according to the outer contour of the target graphic.

In some embodiments, the graphic processing device may directly acquire the number of pieces for forming the target graphic from user-input, and acquire the target sequence of pieces of the tiling puzzle with the number of pieces from a preset piece image sequence.

In other embodiments, the graphic processing device may acquire a piece image input by a user, where the piece image includes multiple pieces for forming the target graphic. The graphic processing device may perform edge detection on the piece image to obtain an outer contour of each piece, and then segment the multiple pieces out of the piece image according to the outer contours of the pieces, so as to form the target sequence of pieces with the segmented pieces.

In one example, the graphic processing device may determine the number of pieces obtained by segmentation after segmenting the multiple pieces out of the piece image, and then acquire the target sequence of pieces of the tiling puzzle with the number of pieces from the preset piece image sequence.

In another example, if the graphic processing device acquires multiple target sequence of piecess of the tiling puzzle with the number of pieces, a similarity between each piece segmented from the piece image and each piece in the target sequence of pieces may be further calculated, to select a target sequence of pieces that meets a preset similarity condition from the multiple target sequence of piecess. Thus, the target sequence of pieces that meets the preset similarity condition is used as a target sequence of pieces finally obtained by the graphic processing device.

The preset similarity condition may include a condition in which pieces in the target sequence of pieces are in one-to-one correspondence with pieces segmented from the piece image, a shape similarity between the piece segmented from the piece image and the corresponding piece in the target sequence of pieces is greater than or equal to a first preset similarity, and an area similarity between the piece segmented from the piece image and the corresponding piece in the target sequence of pieces is greater than or equal to a second preset similarity.

It should be noted that the first preset similarity and the second preset similarity may be preset as needed. For example, the first preset similarity and the second preset similarity may be 90% and 95% respectively.

Thus, in the embodiments of the present disclosure, the graphic processing device may directly extract the target graphic from the target image including the target graphic, and flexibly acquire the target sequence of pieces. Therefore, the efficiency of acquiring the target graphic and the target sequence of pieces is improved.

In some embodiments of the present disclosure, the target image may be an image including a puzzle pattern formed by splicing pieces. The graphic processing device may acquire a target image captured by a user, including a real puzzle pattern formed by splicing real pieces: or the graphic processing device may acquire a target image drawn by a user, including a puzzle pattern formed by splicing pieces. The present disclosure is not limited in this aspect. After acquiring the target image, the graphic processing device may perform binaryzation processing on the target image to obtain a binarized black-and-white image, perform edge detection on the black-and-white image to obtain an outer contour of the target graphic, and then segment the target graphic out of the target image according to the outer contour of the target graphic.

In some embodiments, the graphic processing device may directly acquire the number of pieces for forming the target graphic input by a user in advance, and acquire a target sequence of pieces of a tiling puzzle with the number of pieces from a preset piece image sequence.

In other embodiments, the graphic processing device may directly acquire a user-captured piece image including multiple real pieces, or a user-drawn piece image including multiple pieces. The present disclosure is not limited in this aspect. After acquiring the piece image, the graphic processing device may perform edge detection on the piece image to obtain an outer contour of each piece, and segment the multiple pieces out of the piece image according to the outer contours of the pieces, so as to form the target sequence of pieces with the segmented pieces.

A specific process for the graphic processing device to form the target sequence of pieces with the segmented pieces has been explained above, which is not repeated here.

Thus, in the embodiments of the present disclosure, the graphic processing device may extract the target graphic from the target image including the puzzle pattern formed by splicing pieces, and flexibly acquire the target sequence of pieces. Therefore, the flexibility of acquiring the target graphic and the target sequence of pieces is further improved.

Returning to S120 in FIG. 1, matching calculation is performed on the to-be-matched object groups to obtain matching state parameters of target matching object groups, where the target matching object group is a to-be-matched object group that meets a preset matching condition.

In an embodiment of the present disclosure, for each of the to-be-matched object groups, the graphic processing device may perform matching calculation on a shape region and a piece in the to-be-matched object group. If it is determined that a matching calculation result meets a preset matching condition, the to-be-matched object group is used as a target matching object group, and then matching state parameter of the target matching object group is acquired and recorded. Otherwise, matching state parameter of the to-be-matched object group is not recorded.

Optionally, the matching calculation result may include a first overlap rate between the shape region and the piece in the to-be-matched object group, and the preset matching condition may include a condition in which the first overlap rate between the shape region and the piece in the to-be-matched object group is greater than or equal to a first overlap rate threshold.

The first overlap rate refers to a proportion of an overlap region between the shape region and the piece in the to-be-matched object group relative to the piece.

In an embodiment, the graphic processing device may first determine an overlap region between a shape region and a piece in a to-be-matched object group, calculate a first region area of the overlap region between the shape region and the piece, and then calculate a ratio of the first region area to a piece area of the piece. The ratio is a proportion of the overlap region between the shape region and the piece relative to the piece. Therefore, the ratio is the first overlap rate between the shape region and the piece in the to-be-matched object group.

It should be noted that the first overlap rate threshold may be set as needed. For example, the first overlap rate threshold may be 90%, 95% or 97%, which is not limited here.

In S130, the matching state parameters are traversed to obtain at least one target state parameter group, where the target state parameter group is used in splicing the target sequence of pieces into the target graphic, the target state parameter group includes multiple target matching state parameters, and one target matching state parameter corresponds to a target matching object group to which one piece belongs.

In an embodiment of the present disclosure, the graphic processing device may traverse each of the matching state parameters to obtain at least one group of target matching state parameters based on which the target sequence of pieces may be spliced into the target graphic. Each group of target matching state parameters may form one target state parameter group.

The number of target matching state parameters in each target state parameter group is the same as the number of pieces in the target sequence of pieces, and one target matching state parameter corresponds to a target matching object group to which one piece in the target sequence of pieces belongs.

The tangram is still taken as an example. Each target state parameter group may include seven target matching state parameters, and the seven target matching state parameters are in one-to-one correspondence with seven pieces, i.e., the seven target matching state parameters are matching state parameters for the target matching object groups to which seven different pieces belong.

In an embodiment of the present disclosure, pieces in the target sequence of pieces may be spliced based on the respective target matching state parameters in the target state parameter group, to form the target graphic. Therefore, the target state parameter group may serve as a puzzle answer to a tiling puzzle which takes the target graphic as the question.

In some embodiments of the present disclosure, the matching state parameter may include a geometric parameter corresponding to the overlap region between the piece and the shape region in the target matching object group.

Every two of the target matching state parameters in the target state parameter group meet a preset splicing condition.

Optionally, the preset splicing condition may include a condition in which a second overlap rate between two pieces determined based on the geometric parameter is less than or equal to a second overlap rate threshold.

The second overlap rate refers to a maximum proportion of an overlap region between the two pieces relative to each of the two pieces.

In some embodiments, the geometric parameter may include a first vertex position, such as a first vertex coordinate, where the first vertex position may be a position in the target graphic where a region vertex of the overlap region between the piece and the shape region is located.

In these embodiments, in a process of determining the second overlap rate between the two pieces based on the geometric parameter, the graphic processing device may first calculate a second region area of the overlap region between the two pieces based on the first vertex position of the overlap region between each piece and the corresponding shape region, and then calculate a ratio of the second region area to a piece area of each piece, which is a proportion of the overlap region between the two pieces relative to each piece. Then, a larger one between the two proportions may be used as the second overlap rate between the two pieces.

In other embodiments, the geometric parameter may further include a placement position and a placement angle for placing the piece in the target graphic. At this time, the placement position and the placement angle for placing the piece in the target graphic may be used to characterize a region position and a region angle of the overlap region.

In these embodiments, in a process of determining the second overlap rate between the two pieces based on the geometric parameter, the graphic processing device may first calculate a second region area of the overlap region between the two pieces based on the placement position and the placement angle for placing each piece in the target graphic, and then calculate a ratio of the second region area to a piece area of each piece, which is a proportion of the overlap region between the two pieces relative to each piece. Then, a larger one between the two proportions may be used as the second overlap rate between the two pieces.

It should be noted that the second overlap rate threshold may be set as needed. For example, the second overlap rate threshold may be 5%, 10% or 20%, which is not limited here.

Further, S130 may specifically include:
sequentially performing depth first search (DFS) on matching state parameters corresponding to target matching object groups to which respective pieces belong, based on a sequence order of the target sequence of pieces, to obtain the target state parameter group.

In an embodiment, matching state parameters corresponding to all target matching object groups to which one piece belongs may be put into a to-be-traversed state parameter group, i.e., each piece corresponds to one to-be-traversed state parameter group, and one to-be-traversed state parameter group may include all matching state parameters in which the piece involves.

The graphic processing device may sort the to-be-traversed state parameter groups corresponding to the pieces based on the sequence order of the target sequence of pieces, to obtain sorted to-be-traversed state parameter groups, and then perform DFS on the matching state parameters in the sorted to-be-traversed state parameter groups to find the target state parameter group in which every two of the matching state parameters meet the preset splicing condition.

Further, a process for the graphic processing device to perform the DFS on the matching state parameters in the sorted to-be-traversed state parameter groups may be as follows. The graphic processing device first selects a matching state parameter from a first to-be-traversed state parameter group, selects a matching state parameter from a second group, and determines, based on geometric parameters in the two matching state parameters, a second overlap rate between pieces corresponding to the two geometric parameters. If the second overlap rate is less than or equal to the second overlap rate threshold, the graphic processing device selects a matching state parameter from a third group, processes every two of the selected three matching state parameters, and determines, based on geometric parameters in every two of the matching state parameters, a second overlap rate between pieces corresponding to the two geometric parameters. If the second overlap rate between every two of the pieces is less than or equal to the second overlap rate threshold, the graphic processing device selects a matching state parameter from a fourth group, and processes so on until the graphic processing device selects a matching state parameter from a last group, and puts all the selected matching state parameters into one target state parameter group in a case of determining, based on geometric parameters in all the selected matching state parameters, that a second overlap rate between every two of the pieces in the target sequence of pieces is less than or equal to the second overlap rate threshold.

It should be noted that in the process for the graphic processing device to perform the DFS on the matching state parameters in the sorted to-be-traversed state parameter groups, in order to avoid duplicated traversal results, a traversal path of the graphic processing device is different each time.

In the embodiments of the present disclosure, after acquiring a target graphic and a target sequence of pieces for forming the target graphic, matching calculation may be performed on multiple to-be-matched object groups formed by combining shape regions in the target graphic and pieces in the target sequence of pieces one to one, to obtain multiple matching state parameters of target matching object groups that meet a preset matching condition. Moreover, the matching state parameters are traversed to obtain at least one target state parameter group based on which the target sequence of pieces is spliced into the target graphic. Thus, automatic design of a puzzle answer for a tiling puzzle is realized, which reduces the time consumption for designing the puzzle answer and improves the efficiency of developing a tiling puzzle game.

In another embodiment of the present disclosure, in order to improve the reliability of matching calculation, the matching calculation for the to-be-matched object groups may be performed by using each key point of the target graphic and each piece vertex of each piece, to obtain the matching state parameters of the target matching object groups.

In some embodiments of the present disclosure, before S120, the graphic processing method may further include:
performing key point detection on the target graphic to obtain multiple key points, where each of the key points is located in at least one shape region.

In an embodiment, the graphic processing device may perform key point detection on the target graphic using a preset key point detection algorithm, to obtain multiple key points.

In order to avoid the existence of a noise key point in the key points, the graphic processing device may calculate a key point distance between every two of the key points based on key point positions of the key points such as key point coordinates, cluster the multiple key points, i.e., cluster the multiple key points whose key point distance is less than a preset distance threshold into a key point cluster to obtain at least one key point cluster, calculate a cluster center position of each key point cluster such as a cluster center coordinate based on key point positions of key points in each key point cluster, and use a pixel point corresponding to the cluster center position as a finally obtained key point in the key point detection performed on the target graphic. Thus, the noise key point obtained in performing the key point detection on the target graphic may be removed.

In these embodiments, optionally, S120 may specifically include:
for respective shape regions to which the key points correspond, sequentially performing the matching calculation for each of the pieces and each of the shape regions where the key points are located, based on the sequence order of the target sequence of pieces, to obtain the matching state parameters.

In an embodiment, the graphic processing device may perform pairwise matching calculation for the shape regions to which the key points correspond and each of the pieces in a preset key point detection order. In a process of performing the pairwise matching calculation for the shape regions corresponding to respective key points and each of the pieces, the matching calculation may be sequentially performed, based on the sequence order of the target sequence of pieces, on each of the pieces and the to-be-matched object groups of respective shape regions where the key points are located.

Optionally, the key point detection order may be an order of key point positions from high to low in the target graphic. If there are at least two key point positions at a same height, the key point detection order may further be an order of key point positions from left to right in the target graphic.

Further, the performing the matching calculation on each of the pieces and the respective shape regions where the key points are located to obtain the matching state parameters may specifically include:
for each piece vertex of each piece, if the piece vertex is superposed on the key point, performing the matching calculation on the piece corresponding to the piece vertex and each of the shape regions to which the key point correspond, to obtain the matching state parameters.

In an embodiment, in a process for the graphic processing device to perform the matching calculation on the to-be-matched object groups including each of the pieces and each of the shape regions where the key points are located, for each piece, the graphic processing device may sequentially superpose each piece vertex of the piece with the key point in a preset vertex order corresponding to the piece by starting from a preset initial vertex corresponding to the piece: and in a case that each piece vertex of the piece is superposed on the key point, perform the matching calculation on the to-be-matched object groups which include the piece corresponding to the piece vertex and the shape regions corresponding to the key point to obtain the matching state parameters.

It should be noted that the preset vertex order corresponding to the piece may be preset as needed, which is not limited here. For example, the preset vertex order may be a clockwise or counterclockwise order. The preset initial vertex corresponding to the piece may be preset as needed, which is not limited here.

Optionally, the performing the matching calculation on the piece corresponding to the piece vertex and each of the shape regions corresponding to the key point to obtain the matching state parameters may specifically include:
rotating the piece corresponding to the piece vertex by taking the piece vertex as a rotation center: and
in a process of rotating the piece corresponding to the piece vertex, each time a rotation angle reaches a preset angle, performing the matching calculation on the piece corresponding to the piece vertex and each shape region having an overlap region with the piece to obtain the matching state parameters of the target matching object groups that meet the preset matching condition.

In an embodiment, the graphic processing device may rotate a piece by a preset angle by taking a piece vertex of the piece as a rotation center in a case that the piece vertex is superposed on a key point. In a process of rotating the piece, each time the piece is rotated by the preset angle, the graphic processing device may perform the matching calculation on a to-be-matched object group which includes the piece and a shape region having an overlap region with the piece, to obtain the matching state parameters.

Optionally, each piece may correspond to a preset initial angle. The graphic processing device may first place a piece at the preset initial angle in a case that a piece vertex of the piece is superposed on a key point, and then rotate the piece for one circle in a preset rotation direction from the preset initial angle.

It should be noted that the preset initial angle may be an initial angle of an included angle between a right side adjacent to the piece vertex and a horizontal positive direction, or it may be defined as an initial angle of other included angles, which is not limited here. The preset rotation direction may be a clockwise or counterclockwise direction, which is not limited here.

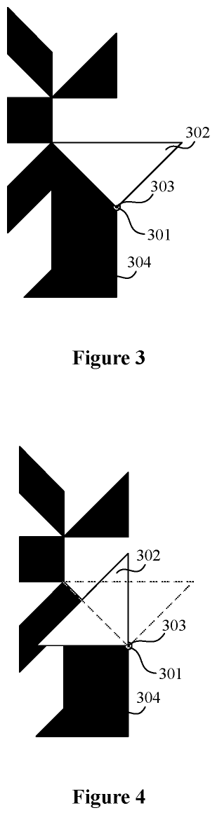

FIG. 3 shows a schematic diagram of a scene in which a key point is superposed on a piece vertex according to an embodiment of the present disclosure. FIG. 4 shows a schematic diagram of a scene of rotating a piece according to an embodiment of the present disclosure.

As shown in FIG. 3, in a case that a key point 301 is superposed with a piece vertex 303 of a piece 302, a preset initial angle may be 45°, and a horizontal positive direction may be a horizontal rightward direction in FIG. 3. The graphic processing device may calculate a first region area of an overlap region between the piece 302 and a shape region 304 corresponding to the key point 301, and then calculate a ratio of the first region area to a piece area of the piece 302, which is a proportion of the overlap region between the shape region 304 and the piece 302 relative to the piece 302. Therefore, the ratio is a first overlap rate between the shape region 304 and the piece 302. If a first overlap rate threshold is 95% and the first overlap rate shown in FIG. 3 is less than 95%, a to-be-matched object to which the piece 302 and the shape region 304 belong is not used as a to-be-matched target object, and a geometric parameter corresponding to the overlap region between the piece 302 and the shape region 304 is not acquired.

As shown in FIG. 4, in a process of rotating the piece 302 counterclockwise for one circle from 45° by taking the piece vertex 303 as the rotation center, if the preset angle is 45°, if the piece 302 rotates by 45° to make a piece angle (an included angle between a right side adjacent to the piece vertex and a horizontal positive direction) reach 90°, as shown by the piece 302 drawn with solid line in FIG. 4, the graphic processing device may calculate a first region area of an overlap region between the piece 302 and the shape region 304 corresponding to the key point 301, and then calculate a ratio of the first region area to a piece area of the piece 302, which is a proportion of the overlap region between the shape region 304 and the piece 302 relative to the piece 302. Therefore, the ratio is a first overlap rate between the shape region 304 and the piece 302. If the first overlap rate threshold is 95% and the first overlap rate shown in FIG. 4 is less than 95%, a to-be-matched object to which the piece 302 and the shape region 304 belong is not used as a to-be-matched target object, and a geometric parameter corresponding to the overlap region between the piece 302 and the shape region 304 is not acquired.

Further, the graphic processing device may determine a first key point based on a key point detection order, select a first piece based on the sequence order of the target sequence of pieces, select a first piece vertex based on a preset vertex order of the first piece, superpose the first piece vertex with the first key point, rotate the first piece for one circle by taking the first piece vertex as the rotation center, and in a process of rotating the first piece, each time the first piece is rotated by a preset angle, perform matching calculation on a to-be-matched object which includes the first piece and a shape region having an overlap region with the first piece, to obtain matching state parameters. Then, the graphic processing device may repeat the above operations for a case in which a second vertex of the first piece is superposed on the first key point, until a last vertex of the first piece is superposed on the first key point, to complete the matching calculation on the first piece and the shape region corresponding to the key point. The graphic processing device may repeat the above operations on the second piece, the third piece until the last piece by following the sequence order of the target sequence of pieces. Then, the graphic processing device may repeat the above operations on a second key point, a third key point until the last key point by following the key point detection order, to obtain the matching state parameters.

In some embodiments of the present disclosure, the preset angle may be any preset angle, such as 5°, 15° or 45°.

Optionally, in a case that the tiling puzzle is a tangram, the preset angle may be 45°, to reduce the amount of matching calculation and improve the speed of matching calculation.

In other embodiments of the present disclosure, the preset angle may be a greatest common factor of included angles of outer contour of the target graphic at the key points.

In an embodiment, the included angle of the outer contour may be an included angle of an outer contour at a key point on a side of a non-shape region.

In the embodiments of the present disclosure, since the preset angle is the greatest common factor of the included angles of the outer contour, it is possible to avoid careless omission of matching calculation and ensure the reliability of matching calculation while reducing the amount of matching calculation.

In another embodiment of the present disclosure, in order to avoid the careless omission of puzzle answers, a graphic processing method is further provided according to an embodiment of the present disclosure.

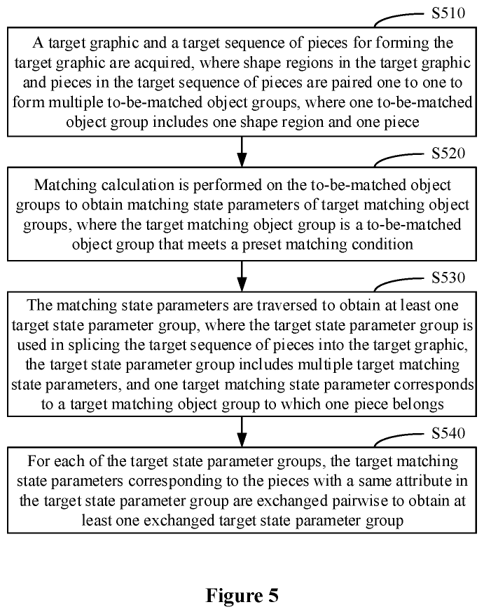

FIG. 5 shows a schematic flowchart of a graphic processing method according to another embodiment of the present disclosure.

As shown in FIG. 5, the graphic processing method may include the following steps S510 to S540.

In S510, a target graphic and a target sequence of pieces for forming the target graphic are acquired, where shape regions in the target graphic and pieces in the target sequence of pieces are paired one to one to form multiple to-be-matched object groups, where one to-be-matched object group includes one shape region and one piece.

In S520, matching calculation is performed on the to-be-matched object groups to obtain matching state parameters of target matching object groups, where the target matching object group is a to-be-matched object group that meets a preset matching condition.

In S530, the matching state parameters are traversed to obtain at least one target state parameter group, where the target state parameter group is used in splicing the target sequence of pieces into the target graphic, the target state parameter group includes multiple target matching state parameters, and one target matching state parameter corresponds to a target matching object group to which one piece belongs.

S510 to S530 are similar to S110 to S130 shown in FIG. 2, which is not repeated here.

In S540, for each of the target state parameter groups, the target matching state parameters corresponding to the pieces with a same attribute in the target state parameter group are exchanged pairwise to obtain at least one exchanged target state parameter group.

In an embodiment of the present disclosure, the graphic processing device may perform pairwise exchange for the target matching state parameters corresponding to the pieces with a same attributes in each target state parameter group to obtain an exchanged target state parameter group, so as to avoid the incompleteness of the target state parameter group obtained by the traversal due to the careless omission of traversal path in the traversal, thus covering all puzzle answers and avoiding the careless omission of the puzzle answers.

In an embodiment, having the same attribute indicates having same piece shape and same piece area, and having different attributes indicate being different in at least one of the piece shape and the piece area.

For each of the target state parameter groups, the target matching state parameters corresponding to the pieces with the same attribute in the target state parameter group may be paired to form at least one to-be-exchanged matching state parameter group. The graphic processing device may exchange two target matching state parameters in each to-be-exchanged matching state parameter group in each target state parameter group, to realize the pairwise exchange of the target matching state parameters corresponding to the pieces with the same attribute in each target state parameter group.

The tangram is still taken as an example. The graphic processing device may perform pairwise exchange on target matching state parameters corresponding to every two of the triangle pieces with a same attribute in the target state parameter group, to obtain an exchanged target state parameter group.

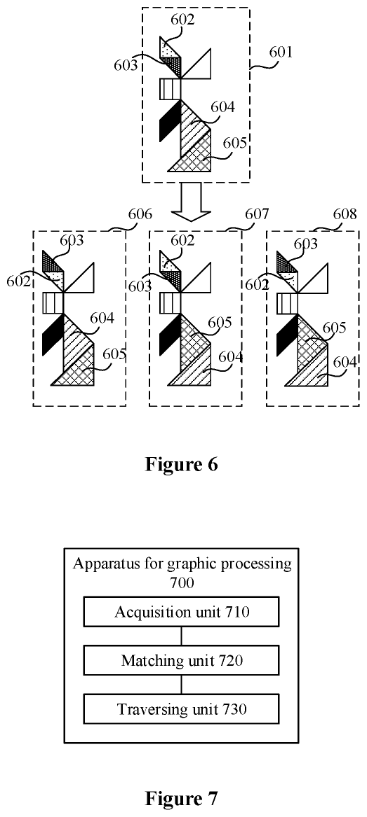

FIG. 6 shows a schematic diagram of a puzzle answer transformation result according to an embodiment of the present disclosure.

As shown in FIG. 6, the graphic processing device may perform pairwise exchange on target matching state parameters corresponding to pieces with a same attribute in a target state parameter group corresponding to a first puzzle answer 601. In an embodiment, the graphic processing device may exchange target matching state parameters corresponding to a first piece 602 and a second piece 603 which have a same attribute in the first puzzle answer 601, to obtain a target state parameter group corresponding to a second puzzle answer 606. The graphic processing device may exchange target matching state parameters corresponding to a third piece 604 and a fourth piece 605 which have a same attribute in the first puzzle answer 601, to obtain a target state parameter group corresponding to a third puzzle answer 607. The graphic processing device may exchange the target matching state parameters corresponding to the first piece 602 and the second piece 603 in the first puzzle answer 601, and exchange the target matching state parameters corresponding to the third piece 604 and the fourth piece 605 in the first puzzle answer 601, to obtain a target state parameter group corresponding to a fourth puzzle answer 608. In another embodiment of the present disclosure, in order to avoid duplication of puzzle answers, a graphic processing method is further provided according to an embodiment of the present disclosure.

In some embodiments of the present disclosure, after S130 shown in FIG. 1, the graphic processing method may further include:
in a case of determining that at least one to-be-deduplicated state parameter group exists in the target state parameter groups, performing deduplication processing on each to-be-deduplicated state parameter group to obtain deduplicated target state parameter groups, where every two of the target state parameter groups in each to-be-deduplicated state parameter group meet a preset duplication condition.

In other embodiments of the present disclosure, after S540 shown in FIG. 5, the graphic processing method may further include:
in a case of determining that at least one to-be-deduplicated state parameter group exists in the target state parameter groups, performing deduplication processing on each to-be-deduplicated state parameter group to obtain deduplicated target state parameter groups, where every two of the target state parameter groups in each to-be-deduplicated state parameter group meet a preset duplication condition.

In an embodiment of the present disclosure, the graphic processing device may first group the target state parameter groups, divide every two of the target state parameter groups that meet the preset duplication condition into one group to obtain at least one to-be-deduplicated state parameter group, and then reserve one target state parameter group in each to-be-deduplicated state parameter group, to complete deduplication processing on each to-be-deduplicated state parameter group to obtain deduplicated target state parameter groups.

Optionally, the matching state parameters may include a geometric parameter corresponding to an overlap region between the piece and the shape region in the target state parameter group, which has been described above and is not repeated here.

Optionally, the preset duplication condition may include a condition in which a third overlap rate between every two same pieces determined based on the geometric parameter is greater than or equal to a third overlap rate threshold.

Two same pieces refer to two pieces with a same attribute. The third overlap rate refers to a maximum proportion of an overlap region between the two same pieces relative to each of the two pieces.

In some embodiments, the geometric parameter may include a first vertex position, where the first vertex position may be a position in the target graphic where a region vertex of the overlap region between the piece and the shape region is located.

In other embodiments, the geometric parameter may further include a placement position and a placement angle for placing the piece in the target graphic.

A method of determining the third overlap rate based on the geometric parameter is similar to the method of determining the second overlap rate based on the geometric parameter, which is not repeated here.

It should be noted that the third overlap rate threshold may be set as needed. For example, the third overlap rate threshold may be 50%, 70%, 90% or 95%, which is not limited here.

In an embodiment, for every two of the target state parameter groups, the graphic processing device may determine a third overlap rate between every two of the pieces with a same attribute based on geometric parameters in the target matching state parameters corresponding to every two of the pieces with the same attribute, and then sequentially compare each third overlap rate with a third overlap rate threshold. If a comparison result is that each third overlap rate is greater than or equal to the third overlap rate threshold, it may be determined that the two target state parameter groups meet a preset duplication condition.

Optionally, in a case that the graphic processing device determines that the preset number of third overlap rates are all greater than or equal to the third overlap rate threshold, the comparison result may be determined to be that each third overlap rate is greater than or equal to the third overlap rate threshold.

A difference between the preset number and the number of pieces in the target sequence of pieces may be 1.

The tangram is still taken as an example. In a case that the graphic processing device determines that third overlap rates corresponding to six pieces are all greater than or equal to the third overlap rate threshold, the comparison result may be determined to be that third overlap rates corresponding to seven pieces are greater than or equal to the third overlap rate threshold.

Thus, in the embodiments of the present disclosure, if the graphic processing device obtains multiple repeated puzzle answers, the deduplication processing may be performed on the obtained puzzle answers to avoid generating repeated puzzle answers.

A graphic processing apparatus is further provided according to an embodiment of the present disclosure, which is described below with reference to FIG. 7.

In some embodiments of the present disclosure, the graphic processing apparatus may be a graphic processing device. The graphic processing device may be a server, an electronic device, or other devices, which is not limited here. The server may be a device with storage and calculation functions such as a cloud server or a server cluster. The electronic device may include a device with communication function such as a mobile phone, a tablet computer, a desktop computer, a notebook computer, an in-vehicle terminal, a wearable electronic device, an all-in-one computer, and a smart home device, or may be a device simulated with a virtual machine or an emulator.

FIG. 7 shows a schematic structural diagram of a graphic processing apparatus according to an embodiment of the present disclosure.

As shown in FIG. 7, the graphic processing apparatus 700 may include an acquisition unit 710, a matching unit 720 and a traversing unit 730.

The acquisition unit 710 may be configured to acquire a target graphic and a target sequence of pieces for forming the target graphic, where shape regions in the target graphic and pieces in the target sequence of pieces are paired one to one to form multiple to-be-matched object groups, where one to-be-matched object group includes one shape region and one piece.

The matching unit 720 may be configured to perform matching calculation on the to-be-matched object groups to obtain matching state parameters of target matching object groups, where the target matching object group is a to-be-matched object group that meets a preset matching condition.

The traversing unit 730 may be configured to traverse the matching state parameters to obtain at least one target state parameter group, where the target state parameter group is used in splicing the target sequence of pieces into the target graphic, the target state parameter group includes multiple target matching state parameters, and one target matching state parameter corresponds to a target matching object group to which one piece belongs.

In the embodiments of the present disclosure, after acquiring a target graphic and a target sequence of pieces for forming the target graphic, matching calculation may be performed on multiple to-be-matched object groups formed by combining shape regions in the target graphic and pieces in the target sequence of pieces one to one, to obtain multiple matching state parameters of target matching object groups that meet a preset matching condition. Moreover, the matching state parameters are traversed to obtain at least one target state parameter group based on which the target sequence of pieces is spliced into the target graphic. Thus, automatic design of a puzzle answer for a tiling puzzle is realized, which reduces the time consumption for designing the puzzle answer and improves the efficiency of developing a tiling puzzle game.

In some embodiments of the present disclosure, the preset matching condition may include a condition in which a first overlap rate between a shape region and a piece in a to-be-matched object group is greater than or equal to a first overlap rate threshold.

In some embodiments of the present disclosure, the graphic processing apparatus 700 may further include a detection unit. The detection unit may be configured to perform key point detection on the target graphic to obtain multiple key points, where each of the key points is located in at least one shape region.

The matching unit 720 may further be configured for: for respective shape regions to which each of the key points corresponds, sequentially performing the matching calculation for each of the pieces and each of the shape regions where the key points are located, according to a sequence order of the target sequence of pieces, to obtain the matching state parameters.

In some embodiments of the present disclosure, the matching unit 720 may further be configured to, for each piece vertex of each piece, if the piece vertex is superposed on the key point, perform the matching calculation on the piece corresponding to the piece vertex and each of the shape regions to which the key point correspond, to obtain the matching state parameters.

In some embodiments of the present disclosure, the matching unit 720 may include a first matching subunit and a second matching subunit.

The first matching subunit may be configured to rotate the piece corresponding to the piece vertex by taking the piece vertex as a rotation center.

The second matching subunit may be configured to: in a process of rotating the piece corresponding to the piece vertex, each time a rotation angle reaches a preset angle, perform the matching calculation on the piece corresponding to the piece vertex and each shape region having an overlap region with the piece to obtain the matching state parameters of the target matching object groups that meet the preset matching condition.

In some embodiments of the present disclosure, the preset angle may be a greatest common factor of included angles of outer contour of the target graphic at the key points.

In some embodiments of the present disclosure, the matching state parameters may include a geometric parameter corresponding to an overlap region between the piece and the shape region.

Accordingly, every two of the target matching state parameters in the target state parameter group may meet a preset splicing condition, and the preset splicing condition may include a condition in which a second overlap rate between two pieces determined based on the geometric parameter is less than or equal to a second overlap rate threshold.

In some embodiments of the present disclosure, the graphic processing apparatus 700 may further include an exchange unit. The exchange unit may be configured to: for each of the target state parameter groups, perform pairwise exchanging for the target matching state parameters corresponding to the pieces with a same attribute in the target state parameter group, to obtain at least one exchanged target state parameter group.

In some embodiments of the present disclosure, the graphic processing apparatus 700 may further include a deduplication unit. The deduplication unit may be configured to: in a case of determining that at least one to-be-deduplicated state parameter group exists in the target state parameter group, perform deduplication processing on each to-be-deduplicated state parameter group to obtain a deduplicated target state parameter group, where every two of the target state parameter groups in each to-be-deduplicated state parameter group meet a preset duplication condition.

The matching state parameters include a geometric parameter corresponding to an overlap region between the piece and the shape region in the target state parameter group, and the preset duplication condition includes a condition in which a third overlap rate between every two same pieces determined based on the geometric parameter is greater than or equal to a third overlap rate threshold.

It should be noted that the graphic processing apparatus 700 shown in FIG. 7 may perform various steps in the method embodiments shown in FIGS. 1 to 6, and implement various processes and effects in the method embodiments shown in FIGS. 1 to 6, which is not repeated here.

A graphic processing device is further provided according to an embodiment of the present disclosure. The graphic processing device may include a processor and a memory. The memory may be configured to store executable instructions. The processor may be configured to read the executable instructions from the memory and execute the executable instructions to implement the graphic processing method according to the above embodiments.

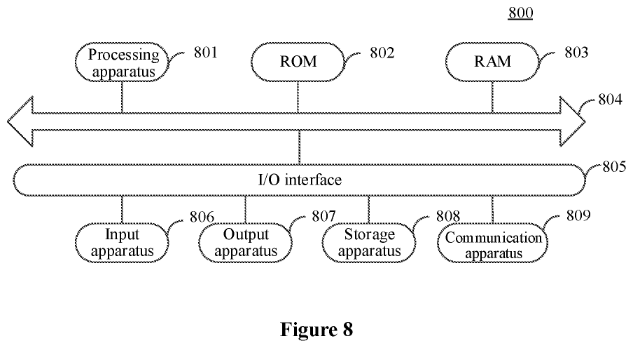

FIG. 8 shows a schematic structural diagram of a graphic processing device according to an embodiment of the present disclosure. Hereinafter, reference is made to FIG. 8, which shows a schematic structural diagram of a graphic processing device 800 suitable for implementing the embodiments of the present disclosure.

The graphic processing device 800 in the embodiment of the present disclosure may be a server, an electronic device, or other devices, which is not limited here. The server may be a device with storage and calculation functions such as a cloud server or a server cluster. The electronic device may include a device with communication function such as a mobile phone, a tablet computer, a desktop computer, a notebook computer, an in-vehicle terminal, a wearable electronic device, an all-in-one computer, and a smart home device, and may also be a device simulated with a virtual machine or an emulator.

It should be noted that the graphic processing device 800 shown in FIG. 8 is only exemplary, and should not indicate any limitation to the function and scope of application of the embodiments of the present disclosure.

As shown in FIG. 8, the graphic processing device 800 may include a processing apparatus (e.g., a central processing unit or a graphics processor) 801, which may execute various operations and processing based on a program stored in a read only memory (ROM) 802 or a program loaded from a storage apparatus 808 into a random access memory (RAM) 803, to implement the graphic processing method according to the above embodiments. The

RAM 803 is further configured to store various programs and data required by the graphic processing device 800 to perform an operation. The processing apparatus 801, the ROM 802 and the RAM 803 are connected to each other through a bus 804. An input/output (I/O) interface 805 is also connected to the bus 804.

Generally, the I/O interface 805 may be connected to: an input apparatus 806, such as a touch screen, a touch panel, a keyboard, a mouse, a camera, a microphone, an accelerometer, and a gyroscope: an output apparatus 807, such as a liquid crystal display (LCD), a speaker, and a vibrator: a storage apparatus 808 such as a magnetic tape and a hard disk: and a communication apparatus 809. The communication apparatus 809 enables wireless or wired communication between the graphic processing device 800 and other devices for data exchanging. Although FIG. 8 shows a graphic processing device 800 having various components, it should be understood that the illustrated components are not necessarily required to all be implemented or included. Alternatively, more or fewer components may be implemented or included.

A computer readable storage medium storing a computer program is further provided according to an embodiment of the present disclosure. The computer program, when executed by a processor, causes the processor to implement the graphic processing method according to the above embodiments.

Particularly, according to the embodiments of the present disclosure, the processes described above with reference to the flowcharts may be implemented as a computer software program.

A computer program product is further provided according to an embodiment of the present disclosure. The computer program product may include a computer program that, when executed by a processor, causes the processor to implement the graphic processing method according to the above embodiments.

For example, a computer program product is further provided as an embodiment in the present disclosure, including a computer program carried on a non-transitory computer readable medium. The computer program includes program code for performing the method shown in the flowchart, to implement the graphic processing method according to the above embodiments. In the embodiment, the computer program may be downloaded and installed from the network via the communication apparatus 809, or installed from the storage apparatus 808, or installed from the ROM 802. When the computer program is executed by the processing apparatus 801, the functions defined in the graphic processing method according to the embodiment of the present disclosure are performed.

It is to be noted that, the computer readable medium mentioned herein may be a computer readable signal medium or a computer readable storage medium or any combination thereof. The computer readable storage medium may be, but is not limited to, a system, an apparatus, or a device in an electronic, magnetic, optical, electromagnetic, infrared, or semi-conductive form, or any combination thereof. The computer readable storage medium may be, but is not limited to, an electrical connection with one or more wires, a portable computer disk, a hard disk, a random access memory (RAM), a read only memory (ROM), an erasable programmable read only memory (EPROM or flash memory), an optical fiber, a portable compact disc read only memory (CD-ROM), a light storage device, a magnetic storage device or any proper combination thereof. In the present disclosure, the computer readable storage medium may be any tangible medium containing or storing a program, and the program may be used by or in combination with an instruction execution system, apparatus, or device. In the present disclosure, the computer readable signal medium may be a data signal transmitted in a baseband or transmitted as a part of a carrier wave and carrying computer readable program codes. The transmitted data signal may be in various forms, including but not limited to an electromagnetic signal, an optical signal or any proper combination thereof. The computer readable signal medium may also be any computer readable medium other than the computer readable storage medium, and may send, propagate or transmit programs to be used by or in combination with an instruction execution system, apparatus or device. The program codes included in the computer readable medium may be transmitted via any proper medium including but not limited to: a wire, an optical cable, radio frequency (RF) and the like, or any proper combination thereof.

In some embodiments, the client and the server may communicate using any currently known or future developed network protocol such as HTTP, and may be interconnected with any form or medium of digital data communication (e.g., a communication network). Examples of the communication network include a local area network (“LAN”), a wide area network (“WAN”), the internet (e.g., the Internet), and an end-to-end network (e.g., ad hoc end-to-end network) or any of a currently known or a future developed network.

The computer readable medium may be incorporated in the graphic processing device, or may exist alone without being assembled into the graphic processing device.

The computer readable medium carries one or more programs. The one or more programs, when executed by the graphic processing device, cause the graphic processing device to:
acquire a target graphic and a target sequence of pieces for forming the target graphic, where shape regions in the target graphic and pieces in the target sequence of pieces are paired one to one to form multiple to-be-matched object groups, where one to-be-matched object group includes one shape region and one piece: perform matching calculation on the to-be-matched object groups to obtain matching state parameters of target matching object groups, where the target matching object group is a to-be-matched object group that meets a preset matching condition: and traverse the matching state parameters to obtain at least one target state parameter group, where the target state parameter group is used in splicing the target sequence of pieces into the target graphic, the target state parameter group includes multiple target matching state parameters, and one target matching state parameter corresponds to a target matching object group to which one piece belongs.

In the embodiments of the present disclosure, the computer program code for performing the operations disclosed in the present disclosure may be written in one or more programming languages or combinations thereof. The programming languages include but are not limited to an object-oriented programming language, such as Java, Smalltalk, and C++, and a conventional procedural programming language, such as C language or a similar programming language. The program code may be executed entirely on a user computer, partially on the user computer, as an standalone software package, partially on the user computer and partially on a remote computer, or entirely on the remote computer or a server. In a case involving a remote computer, the remote computer may be connected to a user computer or an external computer through any kind of network including local area network (LAN) or wide area network (WAN). For example, the remote computer may be connected through Internet connection by an Internet service provider.

Flowcharts and block diagrams in the drawings illustrate the architecture, functions and operations that may be implemented by the system, method and computer program product according to the embodiments of the present disclosure. In this regard, each block in the flowcharts or the block diagrams may represent a module, a program segment, or a part of code. The module, the program segment, or the part of code contains one or more executable instructions for implementing the specified logical function. It should be also noted that, in some alternative implementations, the functions shown in the blocks may be performed in an order different from the order shown in the drawings. For example, two blocks shown in succession may actually be executed in parallel, or sometimes may be executed in a reverse order, which depends on the functions involved. It should also be noted that, each block in the block diagrams and/or the flowcharts and a combination of blocks in the block diagrams and/or the flowcharts may be implemented by a dedicated hardware-based system performing specified functions or operations, or may be implemented by a combination of dedicated hardware and computer instructions.

The units mentioned in the description of the embodiments of the present disclosure may be implemented by means of software, or otherwise by means of hardware. The name of the unit does not constitute a limitation on the unit itself under certain circumstances.

The functions described herein above may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logical device (CPLD) and the like.

In the present disclosure, a machine readable medium may be a tangible medium, which may contain or store a program used by the instruction execution system, apparatus, or device or a program used in combination with the instruction execution system, apparatus, or device. The machine readable medium may be a machine readable signal medium or a machine readable storage medium. The machine readable medium may include, but is not limited to, a system, an apparatus or a device in an electronic, magnetic, optical, electromagnetic, infrared, or semi-conductive form, or any suitable combination thereof. The machine readable storage medium, for example, includes an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination thereof.

The above descriptions are only preferred embodiments of the present disclosure and explanations of the technical principles used in the present disclosure. Those skilled in the art should understand that the scope of the present disclosure is not limited to the technical solution formed by combination of the technical features described above, but also covers other technical solutions formed by any combination of the above technical features or the equivalent features of the technical features without departing from the concept of the present disclosure. For example, the scope of the present disclosure may cover a technical solution formed by replacing the features described above with technical features with similar functions disclosed in (but not limited to) the present disclosure.

In addition, although the above operations are described in a specific order, it should not be understood that these operations are required to be performed in the specific order or performed in a sequential order. In some conditions, multitasking and parallel processing may be advantageous. Similarly, although multiple implementation details are included in the above descriptions, the details should not be interpreted as limitations to the scope of the present disclosure. Some features described in an embodiment may be implemented in combination in another embodiment. In addition, the features described in an embodiment may be implemented individually or in any suitable sub-combination form in multiple embodiments.

Although the subject of the present disclosure has been described according to the structural features and/or logical actions of the method, it should be understood that the subject defined in the claims is not necessarily limited to the features or actions described above. The specific features and actions described above are only examples of the implementation of the claims.

1. A graphic processing method, comprising:
acquiring a target graphic and a target sequence of pieces for forming the target graphic, wherein shape regions in the target graphic and pieces in the target sequence of pieces are paired one to one to form a plurality of to-be-matched object groups, wherein one to-be-matched object group comprises one shape region and one piece;
performing matching calculation on the to-be-matched object groups to obtain matching state parameters of target matching object groups, wherein the target matching object group is a to-be-matched object group that meets a preset matching condition; and
traversing the matching state parameters to obtain at least one target state parameter group, wherein the target state parameter group is used in splicing the target sequence of pieces into the target graphic, the target state parameter group comprises a plurality of target matching state parameters, and one target matching state parameter corresponds to a target matching object group to which one piece belongs.

2. The method according to claim 1, wherein the preset matching condition is that a first overlap rate between the shape region and the piece in the to-be-matched object group is greater than or equal to a first overlap rate threshold.

3. The method according to claim 2, wherein the first overlap rate refers to a proportion of an overlap region between the shape region and the piece in the to-be-matched object group relative to the piece.

4. The method according to claim 1, wherein before performing the matching calculation on the to-be-matched object groups to obtain the matching state parameters of the target matching object groups, the method further comprises:
performing key point detection on the target graphic to obtain a plurality of key points, wherein each of the key points is located in at least one shape region; and
wherein the performing matching calculation on the to-be-matched object groups to obtain matching state parameters of the target matching object groups comprises:
for respective shape regions to which each of the key points corresponds, sequentially performing the matching calculation for each of the pieces and each of the shape regions where the key points are located, according to a sequence order of the target sequence of pieces, to obtain the matching state parameters.

5. The method according to claim 4, wherein the performing the matching calculation for each of the pieces and each of the shape regions where the key points are located to obtain the matching state parameters comprises:
for each piece vertex of each piece, if the piece vertex is superposed on the key point, performing the matching calculation on the piece corresponding to the piece vertex and each of the shape regions to which the key point correspond, to obtain the matching state parameters.

6. The method according to claim 5, wherein the performing the matching calculation on the piece corresponding to the piece vertex and each of the shape regions to which the key point correspond to obtain the matching state parameters comprises:
rotating the piece corresponding to the piece vertex by taking the piece vertex as a rotation center; and
in a process of rotating the piece corresponding to the piece vertex, each time a rotation angle reaches a preset angle, performing the matching calculation on the piece corresponding to the piece vertex and each shape region having an overlap region with the piece to obtain the matching state parameters of the target matching object groups that meet the preset matching condition.

7. The method according to claim 6, wherein the preset angle is a greatest common factor of included angles of outer contour of the target graphic at the key points.

8. The method according to claim 1, wherein the matching state parameter comprise a geometric parameter corresponding to an overlap region between the piece and the shape region in the target matching object group;
wherein every two of the target matching state parameters in the target state parameter group meet a preset splicing condition, and the preset splicing condition is that a second overlap rate between two pieces determined based on the geometric parameter is less than or equal to a second overlap rate threshold.

9. The method according to claim 8, wherein the second overlap rate is a maximum proportion of an overlap region between the two pieces relative to each of the two pieces.

10. The method according to claim 9, wherein the geometric parameter comprises a first vertex position, and the first vertex position is a position in the target graphic where a region vertex of the overlap region between the piece and the shape region in the target matching object group is located.

11. The method according to claim 9, wherein the geometric parameter comprises a placement position and a placement angle for placing the piece of the target matching object group in the target graphic, and the placement position and the placement angle for placing the piece in the target graphic are used to characterize a region position and a region angle of the overlap region.

12. The method according to claim 1, wherein after traversing the matching state parameters to obtain the at least one target state parameter group, the method further comprises:
for each of the target state parameter groups, performing pairwise exchanging for the target matching state parameters corresponding to the pieces with a same attribute in the target state parameter group, to obtain at least one exchanged target state parameter group.

13. The method according to claim 1, further comprising:
in a case of determining that at least one to-be-deduplicated state parameter group exists in the target state parameter groups, performing deduplication processing on each to-be-deduplicated state parameter group to obtain deduplicated target state parameter groups, wherein every two of the target state parameter groups in each to-be-deduplicated state parameter group meet a preset duplication condition.

14. The method according to claim 13, wherein the matching state parameters comprise a geometric parameter corresponding to an overlap region between the piece and the shape region in the target state parameter group, and the preset duplication condition is that a third overlap rate between every two of the pieces with a same attribute determined based on the geometric parameter is greater than or equal to a third overlap rate threshold.

15. The method according to claim 14, wherein the third overlap rate is a maximum proportion of an overlap region between the every two of the pieces with the same attribute relative to each of the two pieces.

16. (canceled)

17. A graphic processing device, comprising:
a processor; and
a memory configured to store executable instructions;
wherein the processor is configured to read the executable instructions from the memory and execute the executable instructions to implement a graphic processing method comprising:
acquiring a target graphic and a target sequence of pieces for forming the target graphic, wherein shape regions in the target graphic and pieces in the target sequence of pieces are paired one to one to form plurality of to-be-matched object groups, wherein one to-be-matched object group comprises one shape region and one piece;
performing matching calculation on the to-be-matched object groups to obtain matching state parameters of target matching object groups, wherein the target matching object group is a to-be-matched object group that meets a preset matching condition; and
traversing the matching state parameters to obtain at least one target state parameter group, wherein the target state parameter group is used in splicing the target sequence of pieces into the target graphic, the target state parameter group comprises a plurality of target matching state parameters, and one target matching state parameter corresponds to a target matching object group to which one piece belongs.

18. A non-transitory computer readable storage medium storing a computer program, wherein the computer program, when executed by a processor, causes the processor to implement a graphic processing method comprising:
acquiring a target graphic and a target sequence of pieces for forming the target graphic, wherein shape regions in the target graphic and pieces in the target sequence of pieces are paired one to one to form plurality of to-be-matched object groups, wherein one to-be-matched object group comprises one shape region and one piece;
performing matching calculation on the to-be-matched object groups to obtain matching state parameters of target matching object groups, wherein the target matching object group is a to-be-matched object group that meets a preset matching condition; and
traversing the matching state parameters to obtain at least one target state parameter group, wherein the target state parameter group is used in splicing the target sequence of pieces into the target graphic, the target state parameter group comprises a plurality of target matching state parameters, and one target matching state parameter corresponds to a target matching object group to which one piece belongs.

19. (canceled)

20. The graphic processing device according to claim 17, wherein the preset matching condition is that a first overlap rate between the shape region and the piece in the to-be-matched object group is greater than or equal to a first overlap rate threshold.

21. The graphic processing device according to claim 20, wherein the first overlap rate refers to a proportion of an overlap region between the shape region and the piece in the to-be-matched object group relative to the piece.

22. The graphic processing device according to claim 17, wherein the processor is configured to implement:
performing key point detection on the target graphic to obtain a plurality of key points, wherein each of the key points is located in at least one shape region; and
for respective shape regions to which each of the key points corresponds, sequentially performing the matching calculation for each of the pieces and each of the shape regions where the key points are located, according to a sequence order of the target sequence of pieces, to obtain the matching state parameters.
